(19) United States
(12) Patent Application Publication
(10) Pub. No.: US 2023/0186268 A1
(43) Pub. Date: Jun. 15, 2023

(54) MANAGEMENT APPARATUS, PROCESSING SYSTEM, AND INFORMATION PROCESSING PROGRAM

(71) Applicant: TOSHIBA TEC KABUSHIKI KAISHA, Tokyo (JP)

(72) Inventor: Hidehiro NAITO, Mishima Shizuoka (JP)

(21) Appl. No.: 17/962,209

(22) Filed: Oct. 7, 2022

(30) Foreign Application Priority Data
Dec. 15, 2021 (JP) 2021-203281

(51) Int. Cl. G06Q 20/20

(52) U.S. Cl. CPC G06Q 20/202; H04L 67/12

(57) ABSTRACT

According to an embodiment, a management apparatus includes a storage unit and a processor. The storage unit stores a plurality of individual identifiers of a plurality of devices connected to a communication network in association with a plurality of network identifiers assigned to the respective devices. The processor identifies a first individual identifier of a first device detached from a communication network, acquires a second individual identifier of a second device connected to the communication network in place of the first device, cancels the association between the first individual identifier and a first network identifier that was assigned to the first device, associates the second individual identifier with the first network identifier, and notifies the second device the first network identifier is now associated with the second individual identifier.

### CROSS-REFERENCE TO RELATED APPLICATION

This application is based upon and claims the benefit of priority from Japanese Patent Application No. 2021-203281, filed Dec. 15, 2021, the entire contents of which are incorporated herein by reference.

### FIELD

Embodiments described herein relate generally to a management apparatus, a processing system, and an information processing program for network managed, reconfigurable systems.

### BACKGROUND

In some point-of-sale (POS) systems, a stand-alone type processing terminal is used. In such a terminal, various peripheral-type devices can be mounted and used in processing executed at the terminal. There is also a POS system in which the various devices that might be used at or with the stand-alone type processing terminal may be independent devices, and these various devices cooperate with each other and/or the terminal via a communication network to permit the required processing to be performed.

For a POS system using networked devices, a plurality of devices of the same type may be installed in each of several checkout lanes. The devices for each of the checkout lanes may all be connected to the same communication network. Therefore, it may be necessary to manage the associations between each device the checkout lanes. For example, when one device is to be replaced due to a mechanical failure of the device or the like, it is necessary to update data used for managing the associations of the devices, which may be troublesome.

In view of such a circumstance, it is desirable to reduce time and effort required for replacing a device or devices in such a networked-type POS system and the like.

### BRIEF DESCRIPTION OF THE DRAWINGS

FIG. 1 is a block diagram of a POS system according to an embodiment.

FIG. 2 is a block diagram of a processing apparatus of a POS system according to an embodiment.

FIG. 3 depicts an example structure of one of data records included in an association table according to an embodiment.

FIG. 4 is a block diagram of a scanner according to an embodiment.

FIG. 5 is a block diagram of a management server according to an embodiment.

FIG. 6 depicts an example structure of one of data records included in a management table according to an embodiment.

FIG. 7 is a flowchart of control processing to be performed by a processor of a scanner according to an embodiment.

FIG. 8 is a flowchart of management processing to be performed by a processor of a management server according to an embodiment.

### DETAILED DESCRIPTION

Embodiments described herein provide a management apparatus, a processing system, and an information processing program that are capable of reducing time and effort for device replacement in, for example, a network connection type POS system or the like.

According to an embodiment, a management apparatus includes a storage unit and a processor. The storage unit stores a plurality of individual identifiers of a plurality of devices connected to a communication network in association with a plurality of network identifiers assigned to the respective devices. The processor identifies a first individual identifier of a first device that has been detached from a communication network, acquires a second individual identifier of a second device connected to the communication network in place of the first device, cancels an association between the first individual identifier and a first network identifier assigned to the first device, and then associates the second individual identifier with the first network identifier and notifies the second device the first network identifier has been associated with the second individual identifier.

Hereinafter, certain example embodiments of a processing system configured as a POS system as one example will be described with reference to the accompanying drawings.

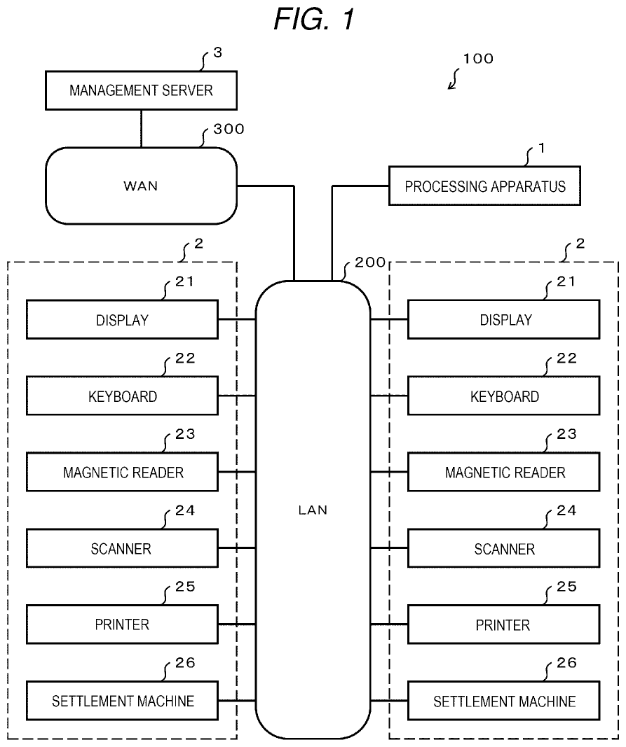

A block diagram of a POS system 100 according to one embodiment is depicted in FIG. 1. The POS system 100 includes a processing apparatus 1, two device groups 2, and a management server 3. The management server 3 in the present embodiment is one example of a management apparatus.

The processing apparatus 1 executes information processing associated with processing transactions, such as merchandise sales transactions, at a store. The processing apparatus 1 is connected to a local area network (LAN) 200.

Each of the device groups 2 includes a display 21, a keyboard 22, a magnetic reader 23, a scanner 24, a printer 25, and a settlement machine 26. The number of the device groups 2 included in the POS system 100 may be arbitrarily selected and may be any number of one or more. The appropriate number of device groups 2 can be set according to the size of the store in which the POS system 100 is being provided. Typically, at least one device group 2 is associated with each one of the checkout lanes at the store. The device group 2 is used for handling a transaction of a customer who enters the associated checkout lane. Each of the display 21, the keyboard 22, the magnetic reader 23, the scanner 24, the printer 25, and the settlement machine 26 is configured as an independent device in this example. Each such device within a device group 2 is installed in the vicinity of the same checkout lane to which the device group 2 is particularly associated. The display 21, the keyboard 22, the magnetic reader 23, the scanner 24, the printer 25, and the settlement machine 26 are individually connected to the LAN 200. In the following, the display 21, the keyboard 22, the magnetic reader 23, the scanner 24, the printer 25, and the settlement machine 26 may sometimes be referred to as “peripheral devices” when it is unnecessary to distinguish specifically from each such device of a device group 2 or between device groups 2.

A device group 2 may include other devices in addition to, or besides, the display 21, the keyboard 22, the magnetic reader 23, the scanner 24, the printer 25, and the settlement machine 26. The device group 2 in some examples might not include one or more of the display 21, the keyboard 22, the magnetic reader 23, the scanner 24, the printer 25, and the settlement machine 26. Different device groups 2 may include different devices from each other. Examples of other peripheral devices that may be included in a device group 2 include, for example, a touch panel, a wireless tag reader, a weighing scale, and a contactless card reader. In some examples, multiple instances of the same peripheral device type, such as a display, may be included in the same device group 2.

The display 21 displays a screen for presenting information to an operator, such as a store clerk or a customer.

The keyboard 22 is provided with a plurality of keys that can be operated by an operator. The keyboard 22 receives an instruction of the operator by the pressing of these keys or the like.

The magnetic reader 23 reads data magnetically recorded on a magnetic-type card. The magnetic card can be, a membership card, a point card, a loyalty program card, or the like.

The scanner 24 reads a barcode, a two-dimensional code, or the like (herein may also be collectively referred to as a barcode) displayed on a commodity.

The printer 25 prints a receipt, a sales slip, coupons, vouchers, or the like on receipt paper. The printer 25 discharges the receipt paper on which the above described information has been printed from a receipt discharge port.

The settlement machine 26 executes processing for settlement by a settlement method selected from among various available settlement methods, such as cash settlement, credit settlement, electronic money settlement, or barcode settlement (e.g., voucher-based settlement).

The management server 3 can communicate with each peripheral device included in the device group 2 via a wide area network (WAN) 300 and/or the LAN 200. The management server 3 manages each peripheral device included in the device group 2. The management server 3 is implemented as, for example, a cloud server.

The LAN 200 is, for example, an in-store LAN. The LAN 200 is connected to the WAN 300.

The WAN 300 is, for example, the Internet. As the WAN 300, another type of communication network such as a virtual private network (VPN) may be used, or a plurality of types of communication networks may be used in combination.

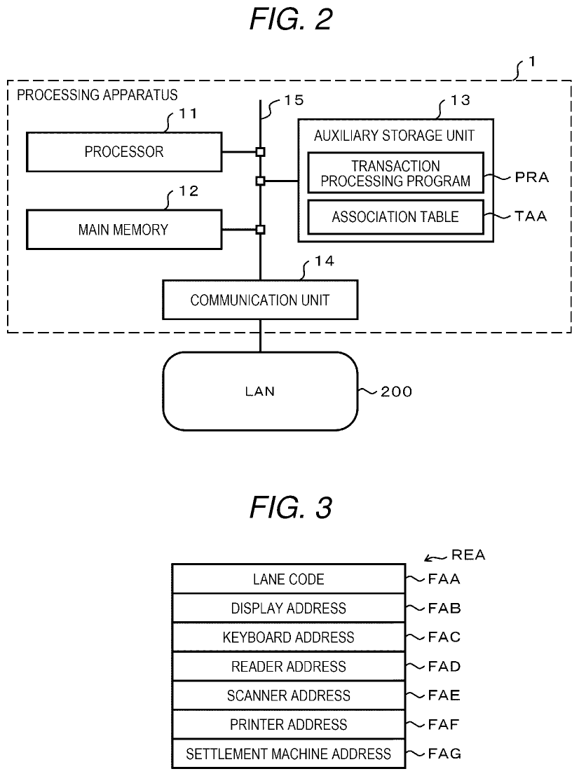

As shown in FIG. 2, the processing apparatus 1 includes a processor 11, a main memory 12, an auxiliary storage unit 13, a communication unit 14, and a transmission path 15. As hardware of the processing apparatus 1, a general-purpose server apparatus can be used when appropriately configured by software or the like.

The processor 11, the main memory 12, and the auxiliary storage unit 13 are connected by the transmission path 15 for implementing processing of the transaction using the device group 2.

The processor 11 corresponds to a central part of a computer. The processor 11 executes the information processing for processing the transaction based on an information processing program, such as an operating system, middleware, and/or an application program, stored in the main memory 12 and the auxiliary storage unit 13. The information processing program may comprise a plurality of programs operating in concert and/or in sequence.

The main memory 12 includes a nonvolatile memory region and a volatile memory region. The main memory 12 stores the information processing program (or programs) in the nonvolatile memory region. The main memory 12 may store data necessary for the processor 11 to execute various types of information processing in the nonvolatile or volatile memory region. The main memory 12 uses the volatile memory region as a work area in which data can be appropriately rewritten (overwritten) by the processor 11.

The auxiliary storage unit 13 can be a storage device, such as an electric erasable programmable read-only memory (EEPROM), a hard disk drive (HDD), or a solid-state drive (SSD). The auxiliary storage unit 13 stores data to be used by the processor 11 in executing various types of information processing as well as data generated by the processing of the processor 11. The auxiliary storage unit 13 may store the information processing program (or programs). In the present embodiment, the auxiliary storage unit 13 stores a transaction processing program PRA as one of the information processing programs. The transaction processing program PRA is an application program that describes a procedure of the information processing (herein may also be referred to as transaction processing) for processing a merchandise sales transaction or the like. A part of a storage region of the auxiliary storage unit 13 is used as an association table TAA. The association table TAA is a data table indicating association or relations between the checkout lanes and the peripheral devices included in the device group 2.

The communication unit 14 executes processing for data communication via the LAN 200.

The transmission path 15 includes an address bus, a data bus, a control signal line, and the like. The transmission path 15 transmits data and signals exchanged between the connected units.

FIG. 3 is a diagram schematically illustrating a structure of one of data records REA included in the association table TAA. A data record REA is associated with each of the checkout lanes of the store that has the POS system 100 installed. If a plurality of checkout lanes are provided in the store, the association table TAA includes a plurality of data records REA (e.g., one for each checkout lane).

The data record REA includes fields FAA, FAB, FAC, FAD, FAE, FAF, and FAG. A lane code is defined for identifying the associated checkout lanes and is placed in the field FAA. An internet protocol (IP) address (or other network identifier) assigned to the display 21 installed in the associated checkout lane is placed in the field FAB. An IP address assigned to the keyboard 22 installed in the associated checkout lane is placed in the field FAC. An IP address assigned to the magnetic reader 23 installed in the associated checkout lane is placed in the field FAD. An IP address assigned to the scanner 24 installed in the associated checkout lane is placed in the field FAE. An IP address assigned to the printer 25 installed in the associated checkout lane is placed in the field FAF. An IP address assigned to the settlement machine 26 installed in the associated checkout lane is placed in the field FAG.

The association table TAA is written to the auxiliary storage unit 13 at the time of, for example, manufacturing or setting up of the POS system 100.

In general, each peripheral device included in a device group 2 autonomously implements its desired or expected function.

Aspects of the scanner 24 will be described as a representative example of a peripheral device in a device group 2.

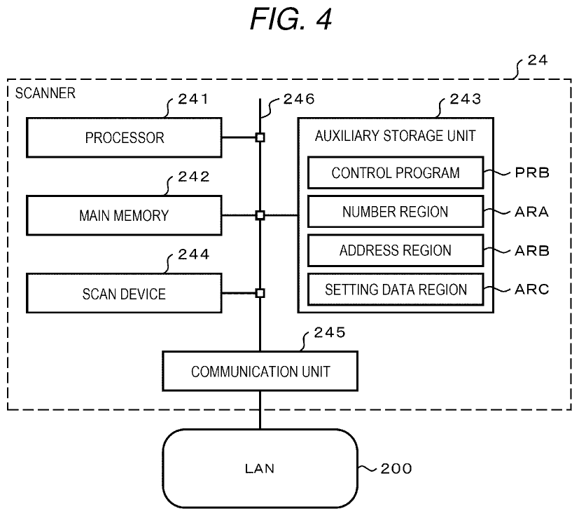

FIG. 4 is a block diagram of the scanner 24. the scanner 24 includes a processor 241, a main memory 242, an auxiliary storage unit 243, a scan device 244, a communication unit 245, and a transmission path 246.

The processor 241, the main memory 242, and the auxiliary storage unit 243 are connected by the transmission path 246.

The processor 241 executes information processing for implementing a scanner function by executing information processing based on an information processing program, such as an operating system, middleware, and/or an application program, stored in the main memory 242 and the auxiliary storage unit 243.

The main memory 242 includes a nonvolatile memory region and a volatile memory region. The main memory 242 stores the necessary information processing program(s) in the nonvolatile memory region. The main memory 242 may store data necessary for the processor 241 to execute various types of information processing in the nonvolatile or volatile memory region. The main memory 242 uses the volatile memory region as a work area in which data can be appropriately rewritten by the processor 241.

The auxiliary storage unit 243 can be a storage device, such as the EEPROM, the HDD, or the SSD. The auxiliary storage unit 243 stores data to be used by the processor 241 in executing various types of information processing and data generated by the processing of the processor 241. The auxiliary storage unit 243 may store the information processing program(s). In the present embodiment, the auxiliary storage unit 243 stores a control program PRB as an information processing program. The control program PRB is an application program that describes a procedure of information processing (herein may also be referred to as control processing) for controlling the functions of the scanner 24. A part of a storage region of the auxiliary storage unit 243 is used as a number region ARA, an address region ARB, and a setting data region ARC. The number region ARA stores a serial number as an individual (unique) identifier for separately identifying each of various scanners 24 in the POS system 100. The address region ARB stores the IP address assigned to the scanner 24. The setting data region ARC stores setting data or setting information indicating various settings related to an operation of the scanner 24. Thus, the auxiliary storage unit 243 stores the IP address as a network identifier in the address region ARB.

The communication unit 245 executes processing for data communication via the LAN 200.

The transmission path 246 includes an address bus, a data bus, a control signal line, and the like. The transmission path 246 transmits data and signals exchanged between various connected units.

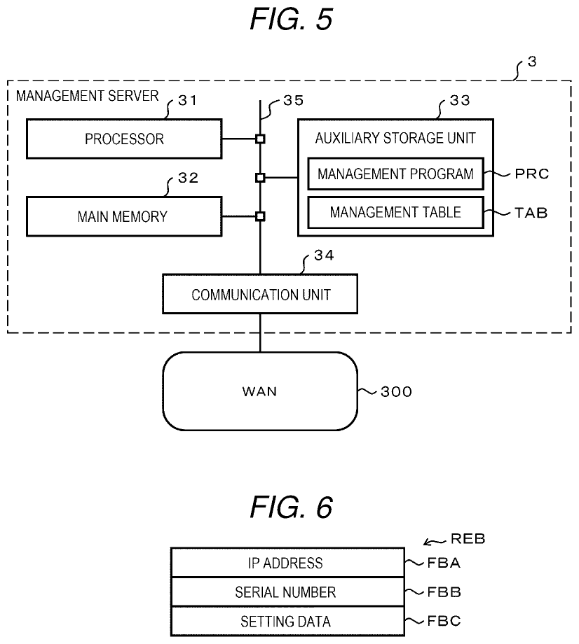

FIG. 5 is a block diagram of the management server 3.

The management server 3 includes a processor 31, a main memory 32, an auxiliary storage unit 33, a communication unit 34, and a transmission path 35. In some examples, a cloud server (cloud-based server) can be used as the management server 3.

The processor 31, the main memory 32, and the auxiliary storage unit 33 are connected by the transmission path 35 for managing each peripheral device included in the device groups 2.

The processor 31 executes information processing for the device management by executing information processing based on an information processing program, such as an operating system, middleware, and/or an application program, stored in the main memory 32 and the auxiliary storage unit 33.

The main memory 32 includes a nonvolatile memory region and a volatile memory region. The main memory 32 stores the information processing program(s) in the nonvolatile memory region. The main memory 32 may store data necessary for the processor 31 to execute various types of information processing in the nonvolatile or volatile memory region. The main memory 32 uses the volatile memory region as a work area in which the data can be appropriately rewritten by the processor 31.

The auxiliary storage unit 33 can be a storage device, such as the EEPROM, the HDD, or the SSD. The auxiliary storage unit 33 stores data to be used by the processor 31 in executing various types of information processing as well as data generated by the processing of the processor 31. The auxiliary storage unit 33 may store the information processing program(s). In the present embodiment, the auxiliary storage unit 33 stores a management program PRC as one of the information processing programs. The management program PRC is an application program that describes a procedure of information processing (herein may also be referred to as management processing) for managing the peripheral devices included in the device groups 2. A part of a storage region of the auxiliary storage unit 33 is used as a management table TAB.

FIG. 6 is a diagram schematically illustrating a structure of one of data records REB included in the management table TAB.

A data record REB is associated with each of the peripheral devices included in the device group 2. The management table TAB is thus a plurality of data records REB. The data record REB includes fields FBA, FBB, and FBC. An IP address assigned to the associated peripheral device is set in the field FBA. A serial number of the associated peripheral device is set in the field FBB. Setting data or setting information related to the peripheral device is set in the field FBC. The management table TAB is written to the auxiliary storage unit 33 at the time of, for example, manufacturing or setting up the POS system 100.

The communication unit 34 executes processing for data communication via the WAN 300.

The transmission path 35 includes an address bus, a data bus, a control signal line, and the like. The transmission path 35 transmits data and signals exchanged between the connected units.

Next, certain operational aspects of the POS system 100 will be described. The specific content and arrangement of the processing is merely an example, and it is possible to change various aspects of the described processing such as an ordering of some of the processing steps, omit some of the processing steps or aspects, add additional processing steps or aspects, and the like. In the following, operation of a scanner 24 among the various peripheral devices included in a device group 2 will be described as representative of the other peripheral devices, and specific descriptions of the other peripheral devices can be considered to generally correspond to that of a scanner 24 unless otherwise noted.

First, when a start of transaction processing is requested by an operation of the keyboard 22, the request is sent from the keyboard 22 to the processing apparatus 1 via the LAN 200. Then, the processor 11 (in processing apparatus 1) starts, according to the transaction processing program PRA as one of the information processing programs stored in the auxiliary storage unit 13, the transaction processing related to the checkout lane to which the keyboard 22 that sent the notification belongs. For example, the processor 11 searches the association table TAA for the data record REA with the IP address matching the keyboard 22 in the field FAC, and executes the transaction processing targeting the lane code in the field FAA of the matching data record REA. The transaction processing in this context may be considered to generally replicate processing results that are substantially the same as the processing executed by a conventional-type POS terminal; however, in this embodiment, the processor 11 separately utilizes the functions of the respective peripheral devices of a device group 2 by communicating with the display 21, the keyboard 22, the magnetic reader 23, the scanner 24, the printer 25, and the settlement machine 26 via the LAN 200 by using the information in data record REA with the target lane code in the field FAA. That is, processor 11 communicates with the appropriate independent peripheral devices (including the scanner 24) by using the IP addresses set in the fields FAB to FAG of the data record REA matched, as described above, by the IP address of the transmitting keyboard 22. Thus, by the processor 11 executing the information processing based on the transaction processing program PRA, the processor 11 executes transaction processing for a merchandise sales transaction or the like.

Accordingly, the processor 11 executes the transaction processing using the peripheral devices included in the device group 2 corresponding to the checkout lane identified by the target lane code. The processor 11 selects the peripheral devices to be used for the transaction processing according to the IP addresses stored in the association table TAA. The processor 11 may execute transaction processing in parallel for two or more checkout lanes (e.g., two or more different device groups 2) at the same time.

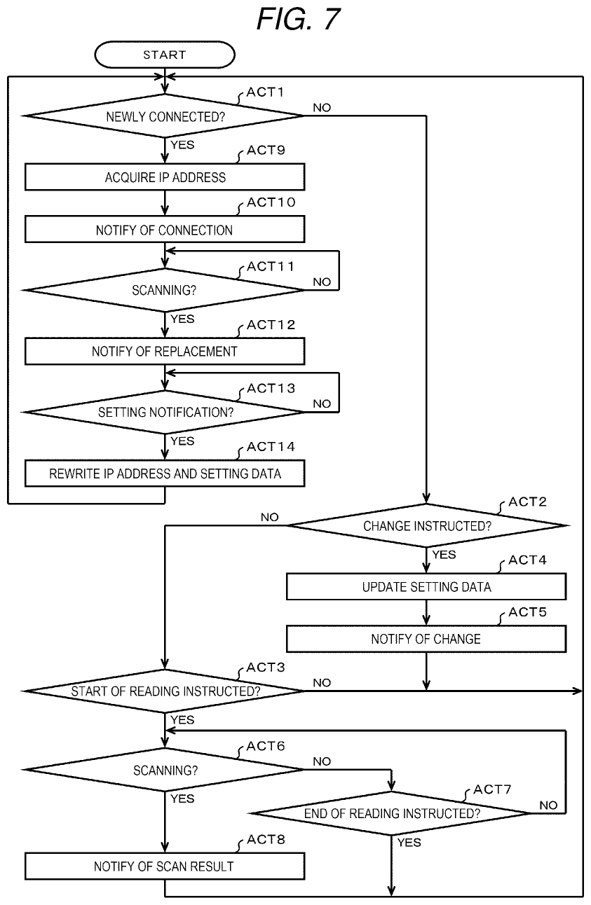

When the scanner 24 is in a normal operation state, the processor 241 repeatedly executes the control processing based on the control program PRB. FIG. 7 is a flowchart of the control processing to be performed by the processor 241 according to the present embodiment.

In ACT 1, the processor 241 checks whether the scanner 24 has been newly connected to the LAN 200. If not, the processor 241 determines NO and proceeds to ACT 2.

In ACT 2, the processor 241 checks whether a change in settings related to the operation of the scanner 24 has been instructed. If not, the processor 241 determines NO and proceeds to ACT 3.

In ACT 3, the processor 241 checks whether a start of reading (scanning) has been instructed. If the not, the processor 241 determines NO and returns to ACT 1.

Thus, in ACT 1 to ACT 3, the processor 241 which is in a standby state waits for any one of a new connection to the LAN 200, an instruction to change the settings, and an instruction to start reading.

Certain settings related to the operations of the scanner 24 can be changed according to user needs or preferences. For example, a function of reading a barcode can be turned on or off. Further, for example, a function of reading a two-dimensional code can be turned on or off. Alternatively, a volume setting of an operation confirmation sound can be adjusted. Such an instruction to change settings may be made by using a user interface device or may be made by any external information terminal connected via the LAN 200.

If the change of a setting is instructed, the processor 241 determines YES in ACT 2, and proceeds to ACT 4.

In ACT 4, the processor 241 updates the setting data stored in the setting data region ARC of the auxiliary storage unit 243 according to the received instruction.

In ACT 5, the processor 241 notifies the management server 3 that the setting has been changed. For example, the processor 241 transmits, from the communication unit 245 to the LAN 200, a change notification to an address of the management server 3. The processor 241 indicates, for example, a settable item being changed and a changed setting value for the item in the notification data. The processor 241 may include the setting data stored in the setting data region ARC of the auxiliary storage unit 243 in the notification data. Thereafter, the processor 241 returns to the standby state corresponding to processing of ACT 1, ACT 2, and ACT 3.

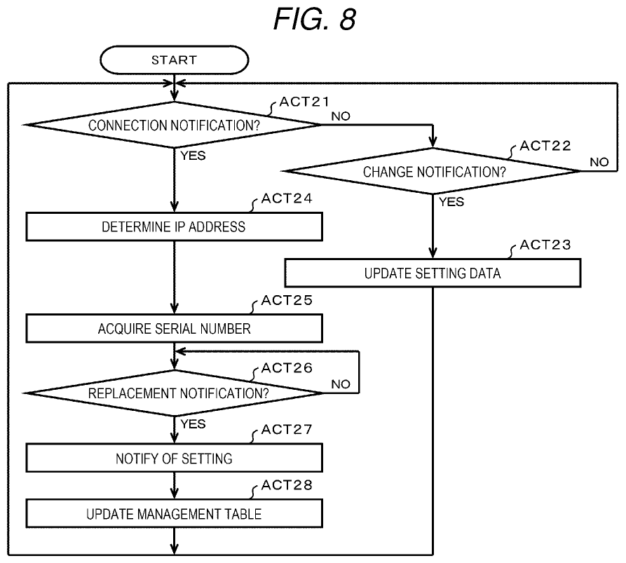

If a management service is to be provided by the management server 3, the processor 31 executes the management processing based on the management program PRC. FIG. 8 is a flowchart of the management processing performed by the processor 31.

In ACT 21, the processor 31 checks whether a connection notification has been sent by any of the peripheral devices belonging to the device group 2. If not, the processor 31 determines NO and proceeds to ACT 22.

In ACT 22, the processor 31 checks whether a change notification has been sent by any of the peripheral devices belonging to the device group 2. If not, the processor 31 determines NO and returns to ACT 21.

Thus, in ACT 21 and ACT 22, the processor 31 waits for the connection notification or the change notification to be sent (and received).

When the change notification is transmitted via the LAN 200 and the WAN 300 and received by the communication unit 34, the processor 31 determines YES in ACT 22 and proceeds to ACT 23.

In ACT 23, the processor 31 updates the setting data based on the change notification. For example, the processor 31 retrieves from the management table TAB stored in the auxiliary storage unit 33 the data record REB which includes the field FBA storing the IP address of a transmission source of the notification data for the change notification. Then, for example, the processor 31 updates the setting data in the field FBC of the retrieved data record REB according to a notification content in the notification data. Thereafter, the processor 31 returns to the standby state of ACT 21 and ACT 22.

The peripheral devices other than the scanner 24 in the device group 2 can also be set as appropriate and notify the management server 3 of a setting change in the same or substantially the same manner as that for the scanner 24 in response to a change instruction of settings.

Accordingly, current settings of various peripheral devices in the POS system 100 are managed based on the management table TAB by the management server 3.

In the processing apparatus 1, if preparation for receiving designation of a commodity is completed in the transaction processing, the processor 11 instructs the scanner 24 installed at the checkout lane of the target lane code to start the reading process. For example, the processor 11 retrieves from the association table TAA the data record REA which has the field FAA storing the target lane code. Then, the processor 11 transmits, from the communication unit 14 to the LAN 200, instruction data designated to the IP address stored in the field FAE of the retrieved data record REA. The processor 11 includes, in the instruction data, a command indicating that the instruction is for staring the reading process.

When the instruction data is transmitted via the LAN 200, the instruction data is received by the communication unit 245 of the scanner 24 to which the IP address is assigned. Upon receipt of the instruction data, the processor 241 of the scanner 24 determines YES in ACT 3 in FIG. 7 and proceeds to ACT 6.

In ACT 6, the processor 241 checks whether scanning by the scan device 244 has been performed. If not, the processor 241 determines NO and proceeds to ACT 7.

In ACT 7, the processor 241 checks whether an end of the reading has been instructed. If not, the processor 241 determines NO and returns to ACT 6.

Thus, in ACT 6 and ACT 7, the processor 241 waits for a scan to be performed or an instruction to end the reading.

The operator holds the barcode, the two-dimensional code, or the like, which is on a commodity to be registered for purchase, over the scan device 244 or holds the scan device 244 over the barcode. The scan device 244 optically scans the barcode, the two-dimensional code, or the like, and outputs scan data as indicated (encoded) by the barcode, the two-dimensional code, or the like. If the function of reading barcodes is turned on through the setting data stored in the setting data region ARC of the auxiliary storage unit 243, the scan device 244 outputs the scan data obtained by scanning the barcode. If the function of reading a two-dimensional code is turned on through the setting data stored in the setting data region ARC of the auxiliary storage unit 243, the scan device 244 outputs the scan data obtained by scanning the two-dimensional code. In response to the output of the scan data from the scan device 244, the processor 241 determines YES in ACT 6 and proceeds to ACT 8.

In ACT 8, the processor 241 notifies the processing apparatus 1 of a scan result. For example, the processor 241 transmits, from the communication unit 245 to the LAN 200, a scan notification designated to the IP address of the processing apparatus 1. The processor 241 includes a commodity code output from the scan device 244 in the scan notification. In some examples, the scan data without any additional processing may be included in the notification data. The processor 241 executing the information processing based on the control program PRB provides the processing apparatus 1 with a scanning function. Thereafter, the processor 241 returns to the standby state of ACT 1 to ACT 3.

In the processing apparatus 1, upon receipt of the scan notification from the scanner 24, the processor 11 retrieves, from the association table TAA stored in the auxiliary storage unit 13, the data record REA which has the field FAE storing the IP address of the scanner 24 providing the scan notification. Then, the processor 11 adds the commodity code included in the scan notification to a commodity list related to the sales transaction processing being performed in association with the lane code set in the field FAA of the retrieved data record REA.

When the processor 11 is notified by any one of the peripheral devices that the operator has made an instruction to shift the operation to transaction accounting (e.g., registration of individual items for purchase has ended), the processor 11 transmits, from the communication unit 14 to the LAN 200, the instruction data addressed to the scanner 24 for instructing the end of the reading process. Once the instruction data has been received by the scanner 24 via the communication unit 245, the processor 241 of the scanner 24 determines YES in ACT 7 in FIG. 7 and returns to the standby state of ACT 1 to ACT 3.

When a failure occurs in one of the peripheral devices, or when a peripheral device is to be updated, that particular device may need to be replaced. In such a case, a worker, an operator, an administrator, or the like (herein may collectively be referred to as a worker) detaches the peripheral device from the LAN 200 and connects a new device to the LAN 200 in place of the detached device. In the case of replacement of a scanner 24, the processor 241 of a scanner 24 newly connected to the LAN 200 will determines YES in ACT 1 and proceeds to ACT 9. Such determination of a new connection may be based on, for example, the scanner 24 not yet having an assigned IP address to be used in connection with LAN 200.

In ACT 9, the processor 241 acquires the IP address to be used in conjunction with the LAN 200. The processor 241 accesses, for example, a dynamic host configuration protocol (DHCP) server that belongs to the LAN 200 and receives an IP address assignment. Then, the processor 241 writes the assigned IP address in the address region ARB of the auxiliary storage unit 243.

In ACT 10, the processor 241 notifies the management server 3 that the scanner 24 has been newly connected to the LAN 200. For example, the processor 241 transmits, from the communication unit 245 to the LAN 200, a connection notification to an address which may be set in advance as a notification destination for the new connection notifications. The processor 241 includes in the notification at least the serial number of the scanner 24 (stored in the number region ARA of the auxiliary storage unit 243) and the newly obtained IP address (stored in the address region ARB of the auxiliary storage unit 243). The processor 241 may include other information other than the serial number and the IP address in the connection notification. For example, if a vendor ID or a product ID is stored in the auxiliary storage unit 243, the processor 241 may include such a vendor ID or product ID in the notification. The vendor ID is, for example, an identifier (e.g., a code number) for identifying a manufacturer of the scanner 24. The product ID is, for example, an identifier for identifying a particular type or model of a product manufactured by a manufacturer.

The connection notification is transmitted to the management server 3 via the LAN 200 and the WAN 300 and received by the communication unit 34 of the management server 3. Upon receipt of the notification, the processor 31 determines YES in ACT 21 in FIG. 8 and proceeds to ACT 24.

In ACT 24, the processor 31 determines or identifies an IP address of the sender of the received notification. The processor 31 temporarily stores the determined IP address in the main memory 32 or the auxiliary storage unit 33. The determined IP address corresponds to the individual identifier of the peripheral device just connected to the LAN 200. Thus, by the determination of the IP address, the corresponding individual identifier of the newly connected device is acquired. Thus, by the processor 31 executing the information processing based on the management program PRC, the processor 31 acquires individual identifiers of the newly connected peripheral devices.

In ACT 25, the processor 31 acquires the serial number in the connection notification. The processor 31 temporarily stores the acquired serial number in the main memory 32 or the auxiliary storage unit 33.

In the scanner 24, once the connection notification is completed in ACT 10 in FIG. 7 as described above, the processor 241 proceeds to ACT 11.

In ACT 11, the processor 241 waits for a barcode or the like to be scanned.

For example, a worker uses the newly connected scanner 24 to read a barcode or two-dimensional code that indicates the serial number of the recently detached scanner 24. Such work can be facilitated by the displaying of a barcode or the like encoding the serial number of the scanners 24 somewhere on the surface of the scanners 24, such as on a rating name plate, product label, or the like. However, the barcode or other information indicating the serial number of the detached scanner 24 may be provided by any method.

When the scan device 244 of the newly connected scanner 24 reads the barcode or the like indicating the serial number of the detached scanner 24, the processor 241 of the newly connected scanner 24 determines YES in ACT 11 and proceeds to ACT 12.

In ACT 12, the processor 241 notifies the management server 3 of the replacement of the previous device. For example, the processor 241 transmits, from the communication unit 245 to the LAN 200, a replacement notification to the address of the management server 3. The processor 241 includes, in the notification, the serial number indicated by the barcode read by the (newly connected) scan device 244.

In the management server 3, after acquiring the serial number from the connection notification in ACT 25 in FIG. 8, the processor 31 proceeds to ACT 26.

In ACT 26, the processor 31 waits for a replacement notification from the newly connected scanner 24. Once the communication unit 34 has received the replacement notification via the LAN 200 and the WAN 300, the processor 31 determines whether the IP address of the sender of the replacement notification matches the IP address of the sender of the connection notification (as determined in ACT 24), and if the IP addresses match, the processor 31 determines YES and proceeds to ACT 27.

In ACT 27, the processor 31 notifies the newly connected peripheral device of the setting information that was used for the just replaced (detached) peripheral device. For example, the processor 31 searches the management table TAB for the data record REB in which the serial number included in the notification data received by the communication unit 34 is set in the field FBB. Then, the processor 31 transmits, from the communication unit 34 to the WAN 300, the setting data set in the fields FBA and FBC of the corresponding data record REB to the new IP address (determined in ACT 24).

In ACT 28, the processor 31 updates the management table TAB to reflect the device replacement in the management operation. For example, the processor 31 respectively rewrites the data in the fields FBB and FBC of the data record REB retrieved in ACT 28 to reflect the serial number acquired in ACT 25 and the previous device setting data notified in ACT 27. Thereafter, the processor 31 returns to the standby state of ACT 21 and ACT 22.

In this manner, the processor 31 uses the serial number as the individual identifier of the detached device based on the receipt of the replacement notification. The processor 31 tracks, by using the management table TAB, the serial number (or other individual identifier) of the device in association with the IP address (or other network identifier) assigned to the device. Then, as part of the described update process, the processor 31 cancels the association between the individual identifier and the network identifier of the detached device.

In the scanner 24, the processor 241 makes the replacement notification in ACT 12 in FIG. 7 and then proceeds to ACT 13.

In ACT 13, the processor 241 waits for a setting notification from the management server 3. Once the communication unit 245 has received the setting notification via the WAN 300 and the LAN 200, the processor 241 determines YES and proceeds to ACT 14.

In ACT 14, the processor 241 rewrites the IP address and the setting data stored in the address region ARB and the setting data region ARC of the auxiliary storage unit 243 to the IP address and the setting data included in the received notification. Thus, by the processor 241 executing the information processing based on the control program PRB functions as a rewritable unit. Thereafter, the processor 241 returns to the standby state of ACT 1 to ACT 3.

In response to the replacement of a scanner 24, the IP address previously assigned to the detached scanner 24 can be re-assigned to the newly attached scanner 24. As a result, even after a scanner 24 is replaced, the processing apparatus 1 can use the newly connected scanner 24 according to the association table TAA without otherwise distinguishing the newly connected scanner 24 from the detached scanner 24. That is, the association table TAA does not itself necessarily need to be updated upon replacement of a peripheral device, and the processing apparatus 1 can operate without any noticeable change before and after the replacement. Since the association table TAA does not need to be updated, the time and effort required for an update or changing of a peripheral device can be effectively reduced.

Further, in response to the replacement of the scanner 24, the setting data indicating the settings of the detached scanner 24 can be downloaded as setting data for the settings of the newly attached scanner 24. In this manner, the newly attached device can be operated in the same or substantially the same manner as the detached device without additional time and effort required for changing the settings of the new device to match the replaced device's settings.

When a device other than the scanner 24 is replaced, the serial number of the detached device may be input via a user interface device provided in the newly attached device, by a user interface device in some other device type than that replaced, or by any information terminal, even one not included in the device group 2 to which the replaced device previously belonged.

The described embodiment can be modified in various ways.

In some examples, the management server 3 may not manage (store) the setting data of peripheral devices or if storing such data, may not download (or otherwise transmit) the replaced device's existing setting data to the new device.

A plurality of processing apparatuses 1 associated with one or more device groups 2 may be provided.

A plurality of management servers 3 associated with one or more device groups 2 may be provided.

The described functions (or portions thereof) of the management server 3 may be provided by the processing apparatus 1. Similarly, the described functions (or portions thereof) of the processing apparatus 1 may be provided by the management server 3.

The concepts of the present disclosure can also be implemented as a processing system that executes information processing for purposes and applications different from POS system 100. For example, the processing system of another embodiment can be implemented for an inventory management system at a warehouse, a transportation object management system at a transportation base, a logistics management system, or the like.

Some or all of the functions described as implemented by the processors 11, 31, and 241 executing a software program or the like as information processing may be implemented instead by dedicated hardware or the like that executes information processing as a specialized logic circuit or the like. Each of the variously described functions may be implemented by combining software control with hardware such as a logic circuit.

While certain embodiments have been described, these embodiments have been presented by way of example only and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A management apparatus, comprising:
a storage device configured to store a plurality of individual identifiers for a plurality of devices in association with a plurality of network identifiers assigned to the respective devices for communication on a communication network;
a processor configured to:
identify a first individual identifier of a first device detached from the communication network;
acquire a second individual identifier of a second device connected to the communication network in place of the first device;
cancel the association between the first individual identifier and a first network identifier assigned to the first device;
associate the second individual identifier with the first network identifier; and
notify the second device the first network identifier is associated with the second individual identifier.

2. The management apparatus according to claim 1, wherein the storage device is further configured to store setting information related to operations of the respective devices in association with the individual identifiers.

3. The management apparatus according to claim 2, wherein the processor is further configured to notify the second device of both the setting information associated with the second individual identifier and the first network identifier.

4. The management apparatus according to claim 1, wherein the processor determines the first individual identifier of the first device based on a notification from the second device.

5. The management apparatus according to claim 1, wherein the processor acquires the second individual identifier in a notification from the second device.

6. The management apparatus according to claim 1, wherein the processor changes the first individual identifier to the second individual identifier in the storage device to change the association of the first network identifier to the second individual identifier.

7. The management apparatus according to claim 1, wherein the storage device stores a table that includes individual identifiers and network identifiers in association with each other.

8. A management processing system for a plurality of devices connected to a communication network and individually assigned a network identifier on the communication network, the system comprising:
a processing apparatus including:
a first storage unit configured to store network identifiers assigned to each assigned device of a plurality of devices to be used with the processing apparatus from among the plurality of devices; and
a first processor configured to:
access each of the assigned devices by using the corresponding network identifier stored in the first storage unit, and
execute information processing using functions of the assigned device;
the plurality of devices, each including:
a second storage unit configured to store the network identifier assigned to the respective device, and
a second processor configured to provide a device function in response to a processing apparatus request via the communication network using the network identifier stored in the second storage unit; and
a management apparatus including:
a third storage unit configured to store individual identifiers for each of the plurality devices in association with the network identifier assigned to each device, and
a third processor configured to:
identify a first individual identifier of a first device in the plurality of devices detached from the communication network,
acquire a second individual identifier of the second device connected to the communication network in place of the first device,
cancel the association between the first individual identifier and a first network identifier assigned to the first device,
associate the second individual identifier with the first network identifier, and
notify the second device the first network identifier is associated with the second individual identifier.

9. The management processing system according to claim 8, wherein the second processor is further configured to overwrite the network identifier stored in the second storage device with the first network identifier sent by the management apparatus.

10. The management processing system according to claim 8, wherein the third storage unit is further configured to store setting information related to functions of the devices in association with the individual identifier.

11. The management processing system according to claim 10, wherein the third processor is further configured to send the setting information associated with the second individual identifier and the first network identifier.

12. The management processing system according to claim 8, wherein the third processor determines the first individual identifier of the first device based on a notification from the second device.

13. The management processing system according to claim 8, wherein the third processor acquires the second individual identifier in a notification from the second device.

14. The management processing system according to claim 8, wherein the third processor overwrites the first individual identifier with the second individual identifier in the third storage device.

15. A non-transitory computer-readable medium storing a program that when executed causes a management apparatus to perform a method comprising:
storing a plurality of individual identifiers of a plurality of devices connected to a communication network in association with a plurality of network identifiers assigned to the respective devices;
identifying a first individual identifier of a first device detached from the communication network;
acquiring a second individual identifier of a second device connected to the communication network in place of the first device;
canceling an association between the first individual identifier and a first network identifier assigned to the first device;
associating the second individual identifier with the first network identifier; and
notifying the second device the first network identifier is associated with the second individual identifier.

16. The non-transitory computer-readable medium according to claim 15, wherein the method further comprises:
storing setting information related to operations of the respective devices in association with the individual identifiers.

17. The non-transitory computer-readable medium according to claim 16, wherein the method further comprises:
notifying the second device of both the setting information associated with the second individual identifier and the first network identifier.

18. The non-transitory computer-readable medium according to claim 15, wherein identifying the first individual identifier is based on a notification from the second device.

19. The non-transitory computer-readable medium according to claim 15, wherein the second individual identifier of the second device is acquired from a notification from the second device.

20. The non-transitory computer-readable medium according to claim 15, wherein the method further comprises:
overwriting the first individual identifier with the second individual identifier in the storage device.
